(19) United States
(12) Patent Application Publication
(10) Pub. No.: US 2026/0149054 A1
(43) Pub. Date: May 28, 2026

(54) POSITIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Seunghyun JEON, Yongin-si (KR); Youngkwang CHO, Yongin-si (KR); Hyunwoo KIM, Yongin-si (KR); Moonju CHO, Yongin-si (KR); Seunghyun LIM, Yongin-si (KR)

(73) Assignee: SAMSUNG SDI CO., LTD., Yongin-si (KR)

(21) Appl. No.: 19/349,180

(22) Filed: Oct. 3, 2025

(30) Foreign Application Priority Data
Nov. 26, 2024 (KR) 10-2024-0171248

(51) Int. Cl. H01M 10/42; H01M 4/02; H01M 4/131; H01M 4/525; H01M 10/052

(52) U.S. Cl. CPC H01M 10/4235; H01M 4/131; H01M 4/525; H01M 10/052; H01M 2004/021; H01M 2004/028

(57) ABSTRACT

Provided are a positive electrode for a rechargeable lithium battery, and a rechargeable lithium battery including the positive electrode. The positive electrode for a rechargeable lithium battery includes a positive electrode current collector, a functional layer disposed on the positive electrode current collector and including a boron nitride and a lithium iron phosphate-based compound, and a positive electrode active material layer disposed on the functional layer and including a positive electrode active material.

### CROSS-REFERENCE TO RELATED APPLICATION

This application claims priority to Korean Patent Application No. 10-2024-0171248 filed in the Korean Intellectual Property Office on Nov. 26, 2024, the entire contents of which are incorporated herein by reference.

### BACKGROUND

### 1. Field

A positive electrode for a rechargeable lithium battery, and a rechargeable lithium battery including the positive electrode are disclosed.

### 2. Description of the Related Art

A rechargeable lithium battery may be recharged and has three or more times as an high energy density per unit weight as a conventional lead storage battery, nickel-cadmium battery, nickel hydrogen battery, nickel zinc battery and the like. A rechargeable lithium battery may also be charged at a high rate, and is thus commercially manufactured for, e.g., a laptop, a cell phone, an electric tool, an electric bike, and the like, and improving additional energy density may be advantageous.

A rechargeable lithium battery is manufactured by injecting an electrolyte solution into an electrode assembly, which includes a positive electrode including a positive electrode active material capable of intercalating/deintercalating lithium ions and a negative electrode including a negative electrode active material capable of intercalating/deintercalating lithium ions.

Battery safety may present a challenge due to ignition problem of rechargeable lithium batteries, and accordingly, various safety tests such as a nail penetration test in which the rechargeable lithium batteries are penetrated with a thin nail are typically conducted in the industry.

In this regard, a method of disposing a functional layer made of or including a lithium iron phosphate-based compound between positive electrode current collector and positive electrode active material layer to improve safety of the rechargeable lithium batteries is known.

However, the functional layer formed of or including the lithium iron phosphate-based compound alone typically has to be at least 4 μm thick to improve the safety of the rechargeable lithium batteries, which is disadvantageous for capacity of the rechargeable lithium batteries.

### SUMMARY

Some example embodiments include an electrode for a rechargeable lithium battery that improves safety, and that does not reduce the capacity of the battery even when a functional layer is formed with a thin thickness.

Some example embodiments include a positive electrode for a rechargeable lithium battery including a positive electrode current collector, a functional layer disposed on the positive electrode current collector and including a boron nitride and a lithium iron phosphate-based compound, and a positive electrode active material layer disposed on the functional layer and including a positive electrode active material.

Some example embodiments include a rechargeable lithium battery including a positive electrode according to the example embodiments.

The positive electrode for a rechargeable lithium battery according to the aforementioned example embodiments may improve safety even when a functional layer is formed with a thin thickness, and may not reduce the capacity of the battery.

### BRIEF DESCRIPTION OF THE DRAWINGS

FIGS. 1 to 4 are schematic views illustrating rechargeable lithium batteries according to some example embodiments.

### DETAILED DESCRIPTION

Hereinafter, example embodiments of the present disclosure are described in detail. However, these embodiments are examples, the present disclosure is not limited thereto and the present disclosure is defined by the scope of claims.

As used herein, when a specific definition is not otherwise provided, it is understood that when an element such as a layer, film, region, or substrate is referred to as being “on” another element, the element can be directly on the other element or intervening elements may also be present therebetween.

As used herein, when a specific definition is not otherwise provided, the singular may also include the plural. In addition, unless otherwise specified, “A or B” may mean “including A, including B, or including A and B.”

As used herein, “combination thereof” may indicate a mixture, a stack, a composite, a copolymer, an alloy, a blend, or a reaction product of constituents.

As used herein, when a definition is not otherwise provided, a particle diameter may be an average particle diameter. In addition, the particle diameter may refer to an average particle diameter (D50), which means the diameter of particles having a cumulative volume of 50 volume % in the particle size distribution. The average particle diameter (D50) may be measured by a method known to those skilled in the art, for example, by a particle size analyzer, or by a transmission electron microscope image, or a scanning electron microscope image. Alternatively, a dynamic light-scattering measurement device is used to perform a data analysis, and the number of particles is counted for each particle size range. From this, the average particle diameter (D50) value may be readily obtained through a calculation. Alternatively, the average particle diameter can be measured using a laser diffraction method. When measuring by the laser diffraction method, for example, the particles to be measured are dispersed in a dispersion medium, and then introduced into a commercially available laser diffraction particle diameter measuring device (e.g., Microtrac MT 3000), and ultrasonic waves of about 28 kHz with an output of 60 W are irradiated to calculate an average particle diameter (D50) on the basis of 50% of the particle diameter distribution in the measuring device.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Positive Electrode for Rechargeable Lithium Battery:

Some example embodiments include a positive electrode for a rechargeable lithium battery including a positive electrode current collector, a functional layer disposed on the positive electrode current collector and including a boron nitride and a lithium iron phosphate-based compound, and a positive electrode active material layer disposed on the functional layer and including a positive electrode active material.

As described above, in the case of a functional layer composed of or including the lithium iron phosphate-based compound alone, the safety of a rechargeable lithium battery may be improved only when the functional layer is formed to a thickness that is greater than or equal to about 4 μm.

On the other hand, the positive electrode for a rechargeable lithium battery of the above example embodiment includes boron nitride together with the lithium iron phosphate-based compound, and because boron nitride is a compound having endothermic properties, even when a functional layer is formed with a thin thickness, safety may be ensured, and capacity of the battery may not be reduced.

Hereinafter, the positive electrode for a rechargeable lithium battery according to the example embodiments is described in detail.

### Boron Nitride

The boron nitride may be or include hexagonal boron nitride (h-BN). The hexagonal boron nitride has high thermal conductivity and high electrical insulation function compared to other structures (e.g., cubic boron nitride, c-BN).

An average particle diameter (D50) of the above boron nitride is not particularly limited, but may be in a range of about 1 μm to about 9 μm. In this range, desired or improved endothermic properties may be exhibited.

Based on a total amount of 100 wt % of the functional layer, the boron nitride may be included in an amount in a range of about 80 wt % to about 90 wt %.

By using boron nitride in a substantial or excessive amount compared to the lithium iron phosphate-based compound, the endothermic properties of the functional layer may be strengthened, and safety of the positive electrode and the rechargeable lithium battery including such a functional layer may be significantly improved.

### Lithium Iron Phosphate-based Compound

The lithium iron phosphate-based compound maybe represented by Chemical Formula 1 below:

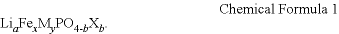

In Chemical Formula 1,
0.9≤a≤1.8, 0.6≤x≤1, 0≤y≤0.4, and 0≤b≤0.1,
M is or includes one or more elements such as or including at least one of Al, B, Ba, Ca, Ce, Co, Cr, Cu, Mg, Mn, Mo, Ni, Se, Si, Sn, Sr, Ti, V, W, Y, Zn, and Zr, and
X is or includes one or more of F, P, and S.

For example, the lithium iron phosphate-based compound may be LiFePO₄, and the particle surface thereof may be coated with a carbon material to improve conductivity.

Based on a total amount of 100 wt % of the functional layer, the lithium iron phosphate-based compound may be included in an amount in a range of about 10 wt % to about 20 wt %. The lithium iron phosphate-based compound contributes to safety and conductivity and can constitute a positive electrode active material.

However, because the lithium iron phosphate-based compound has a lower capacity than other positive electrode active materials, in the functional layer of the above example embodiment, the boron nitride may constitute a main material for improving safety, while the lithium iron phosphate-based compound may constitute a secondary material for improving conductivity.

### Binder

The functional layer may further include a binder for adhering the components constituting the functional layer to the current collector, or for adhering different components together.

The binder may be or include at least one of a non-aqueous binder and an aqueous binder.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, or a combination thereof.

Among the above compounds, polyvinylidene fluoride has high impregnation properties for electrolyte solutions, which may reduce the adhesive strength when the functional layer comes into contact with the electrolyte solution. In contrast, (meth)acrylic resin and polyvinyl alcohol may maintain high adhesive strength even when impregnated with electrolyte solution. Accordingly, the safety of the functional layer using the latter binder may be higher.

For example, the binder may be or include polyacrylic acid (PAA), polyvinyl alcohol (PVA), or a combination thereof. These can be used individually, but can have a synergistic effect when used in combination. When the polyacrylic acid (PAA) and the polyvinyl alcohol (PVA) are used in combination, their weight ratio may be in a range of about 1:10 to about 10:1, about 1:8 to about 8:1, or about 1:6 to about 6:1.

Based on a total amount of 100 wt % of the functional layer, the binder may be included in an amount in a range of about 0.5 to about 5 wt %.

### Thickness of Functional Layer

The thickness of the functional layer including the boron nitride and lithium iron phosphate-based compound may be thinner than the functional layer composed of or including boron nitride alone.

For example, the thickness of the functional layer including the boron nitride and lithium iron phosphate-based compound may be in a range of about 0.1 to about 3 μm, about 0.3 to about 2 μm, or about 0.5 to about 1.5 μm.

Even when the functional layer is formed with a thin thickness as described above, safety can be secured and the capacity of the battery can be maintained without being impaired.

### Structure of Functional Layer and Positive Electrode Active Material Layer

The functional layer and the positive electrode active material layer may be disposed on both surfaces of the positive electrode current collector. The functional layer may include a first functional layer on a first surface of the positive electrode current collector and a second functional layer on a second surface of the positive electrode current collector; and the positive electrode active material layer may include a first positive electrode active material layer on the first functional layer, and a second positive electrode active material layer on the second functional layer.

When the functional layer and the positive electrode active material layer are disposed on both surfaces of the positive electrode current collector, the capacity of the rechargeable lithium battery can be increased while ensuring safety.

### Positive Electrode Active Material Layer

By forming the functional layer with a thin thickness as described above, the positive electrode active material layer may be formed relatively thickly.

For example, when the general thickness ratio of the functional layer composed solely of the boron nitride/the positive electrode active material layer is greater than or equal to about 5/75 (i.e., 1/15), the thickness ratio of the functional layer including the boron nitride and lithium iron phosphate-based compound/the positive electrode active material layer may be less than about 5/75 (i.e., about 1/15), for example, less than or equal to about 4/76, or less than or equal to about 3/77. The lower bound may be greater than or equal to 0, for example, greater than or equal to about 1/79, or greater than or equal to about 2/78. Accordingly, the capacity of the rechargeable lithium battery may be improved.

The descriptions may be applied to both surfaces of positive electrode current collector, respectively.

The positive electrode active material may be or include a compound (lithiated intercalation compound) capable of intercalating and deintercalating lithium. For example, one or more types of composite oxides of lithium and a metal such as or including at least one of cobalt, manganese, nickel, and combinations thereof, may be used.

The composite oxide may be or include a lithium transition metal composite oxide, and examples thereof may include at least one of a lithium nickel-based oxide, a lithium cobalt-based oxide, a lithium manganese-based oxide, a lithium iron phosphate-based compound, a cobalt-free lithium nickel-manganese-based oxide, or a combination thereof.

As an example, a compound represented by any of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, ≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, at least one of a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, or a combination thereof.

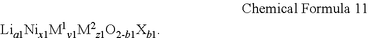

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² each independently is or includes one or more of Al, B, Ba, Ca, Ce, Co, Cr, Cu, Fe, Mg, Mn, Mo, Nb, Si, Sn, Sr, Ti, V, W, and Zr, and X is or includes one or more of F, P, and S.

In Chemical Formula 11, 0.6≤x1≤1, 0≤y1≤0.4, and 0≤z1≤0.4, or 0.8≤x1≤1, 0≤y1≤0.2, and 0≤z1≤0.2.

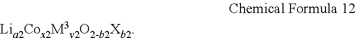

In Chemical Formula 12, 0.9≤a2<1.8, 0.7≤x2≤1, 0≤y2≤0.3, 0.9≤x2+y2≤1.1, and 0≤b2≤0.1, M³ is or includes one or more of Al, B, Ba, Ca, Ce, Cr, Cu, Fe, Mg, Mn, Mo, Ni, Se, Si, Sn, Sr, Ti, V, W, Y, Zn, and Zr, and X is or includes one or more of F, P, and S.

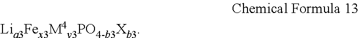

In Chemical Formula 13, 0.9≤a3≤1.8, 0.6≤x3≤1, 0≤y3≤0.4, and 0≤b3≤0.1, M⁴ is or includes one or more of Al, B, Ba, Ca, Ce, Co, Cr, Cu, Mg, Mn, Mo, Ni, Se, Si, Sn, Sr, Ti, V, W, Y, Zn, and Zr, and X is or includes one or more of F, P, and S.

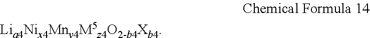

In Chemical Formula 14, 0.9≤a4≤1.8, 0.8≤x4<1, 0<y4≤0.2, 0≤z4≤0.2, 0.9≤x4+y4+z4≤1.1, and 0≤b4≤0.1, M⁵ is or includes one or more of Al, B, Ba, Ca, Ce, Cr, Fe, Mg, Mo, Nb, Si, Sn, Sr, Ti, V, W, and Zr, and X is or includes one or more of F, P, and S.

The lithium iron phosphate-based compound represented by Chemical Formula 13 as the positive electrode active material may have the same, or different, composition as the lithium iron phosphate-based compound included in the functional layer described above.

For example, the positive electrode active material may be or include a high-nickel positive electrode active material in which the nickel content is greater than or equal to about 80 mol %, greater than or equal to about 85 mol %, greater than or equal to about 90 mol %, greater than or equal to about 91%, or greater than or equal to about 94 mol % and less than or equal to about 99 mol %, based on 100 mol % of metal excluding lithium in the lithium transition metal composite oxide. The high-nickel positive electrode active material can achieve high capacity, and can be applied to high-capacity, high-density rechargeable lithium batteries.

The positive electrode active material layer may include a positive electrode active material, and may further include a binder and/or a conductive material.

For example, the positive electrode may further include an additive that can constitute a sacrificial positive electrode.

An amount of the positive electrode active material may be in a range of about 90 wt % to about 99.5 wt % based on 100 wt % of the positive electrode active material layer, and the amount of each of the binder and the conductive material may be in a range of about 0.5 wt % to about 5 wt % based on 100 wt % of the positive electrode active material layer.

The binder may improve the binding properties of positive electrode active material particles with one another and with a current collector. Examples of binders may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

The conductive material is included to provide electrode conductivity, and any electrically conductive material may be used as a conductive material unless the electrically conductive material causes an adverse chemical change. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

### Rechargeable Lithium Battery:

Some example embodiments include a rechargeable lithium battery including: a positive electrode, a negative electrode, and a separator between the positive electrode and the negative electrode, and an electrolyte solution.

Because the rechargeable lithium battery includes the positive electrode of the above-mentioned example embodiment, both safety and capacity may be improved.

Hereinafter, a rechargeable lithium battery according to the above example embodiment is described in detail, excluding any description overlapping with the above-mentioned description.

### Negative Electrode Active Material

The negative electrode active material may include at least one of a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example, crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is an element such as or including at least one of an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core.

The Si-based negative electrode active material or Sn-based negative electrode active material may be mixed with the carbon-based negative electrode active material.

### Negative Electrode

A negative electrode for a rechargeable lithium battery includes a current collector and a negative electrode active material layer on the current collector. The negative electrode active material layer includes a negative electrode active material, and may further include a binder and/or a conductive material.

For example, the negative electrode active material layer may include about 90 wt % to about 99 wt % of the negative electrode active material, about 0.5 wt % to about 5 wt % of the binder, and about 0.5 wt % to about 5 wt % of the conductive material.

The binder adheres the negative electrode active material particles to each other, and adheres the negative electrode active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be or include at least one of Na, K, or Li.

The dry binder is or includes a polymer material capable of being fiberized, and may be or include, for example, at least one of polytetrafluoroethylene, polyvinylidene fluoride, polyvinylidene fluoride-hexafluoropropylene copolymer, polyethylene oxide, or a combination thereof.

The conductive material is included to provide electrode conductivity, and any electrically conductive material may be used as a conductive material unless the electrically conductive material causes an adverse chemical change. Examples of the conductive material include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof.

### Electrolyte Solution

An electrolyte solution for a rechargeable lithium battery includes a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R-CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent may be used alone, or in a mixture of two or more types of solvents.

In addition, when using a carbonate-based solvent, a cyclic carbonate and a chain carbonate may be mixed, and the cyclic carbonate and the chain carbonate may be mixed in a volume ratio in a range of about 1:1 to about 1:9.

The electrolyte solution may further include at least one of vinylethyl carbonate, vinylene carbonate, fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, or a combination thereof as an additive.

The lithium salt dissolved in the organic solvent supplies lithium ions in a battery, enables a basic operation of a rechargeable lithium battery, and improves transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethane sulfonate, lithium difluorobis(oxalato) phosphate (LiDFOB), and lithium bis(oxalato) borate (LiBOB).

### Separator

Depending on the type of rechargeable lithium battery, a separator may be present between the positive and negative electrodes. The separator may include at least one of polyethylene, polypropylene, polyvinylidene fluoride, or a multilayer film of two or more layers thereof, and a mixed multilayer film such as a polyethylene/polypropylene two-layer separator, a polyethylene/polypropylene/polyethylene three-layer separator, a polypropylene/polyethylene/polypropylene three-layer separator, and the like.

The separator may include a porous substrate and a coating layer including an organic material, an inorganic material, or a combination thereof, on one surface, or on both surfaces, of the porous substrate.

The porous substrate may be or include a polymer film formed of or including a polymer such as at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Rechargeable Lithium Battery

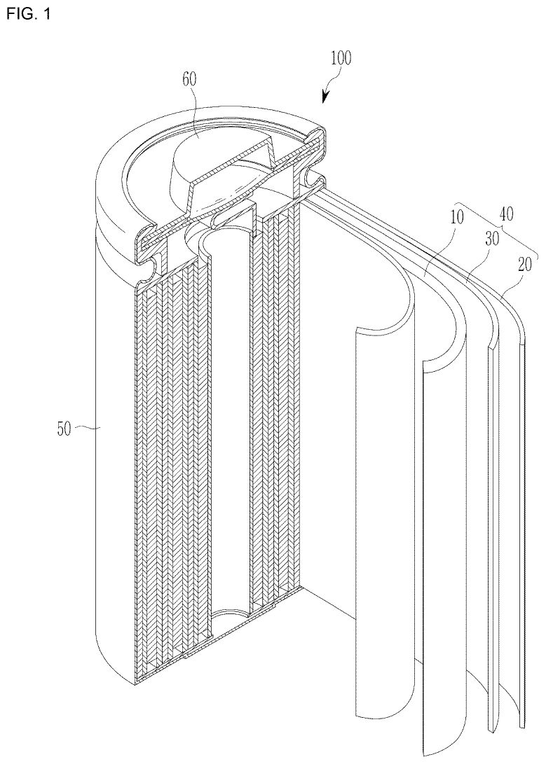

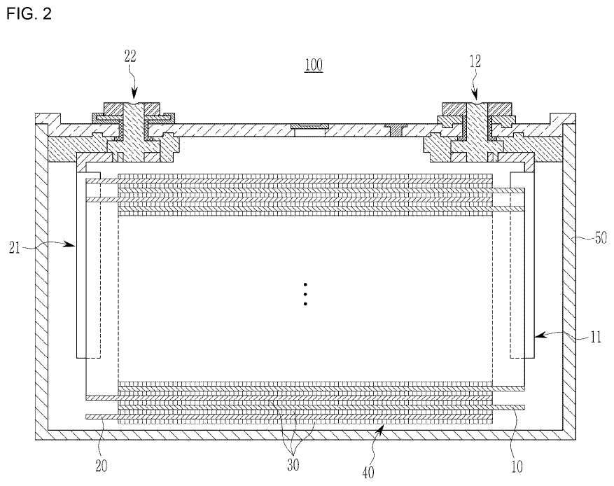

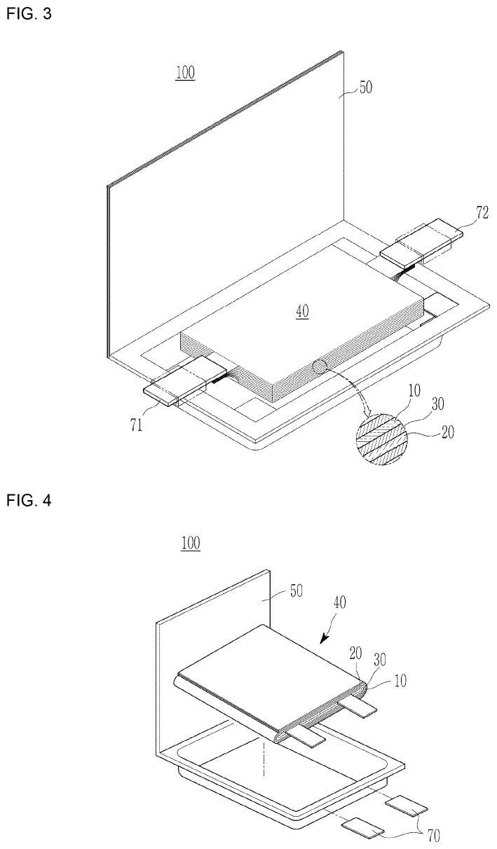

The rechargeable lithium battery may be classified into cylindrical, prismatic, pouch, or coin-type batteries, and the like depending on the shape. FIGS. 1 to 4 are schematic views showing the rechargeable lithium battery according to some example embodiments, where FIG. 1 is a cylindrical battery, FIG. 2 is a prismatic battery, and FIGS. 3 and 4 are a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electric path for inducing the current formed in the electrode assembly 40 to the outside of the battery 100.

The rechargeable lithium battery according to some example embodiments may be applicable to, e.g., automobiles, mobile phones, and/or various types of electrical devices, but the present disclosure is not limited thereto.

Examples and comparative examples of the present disclosure are described below. However, the following examples are only examples of the present disclosure, and the present disclosure is not limited to the following examples.

### Example 1-1

### (1) Manufacturing of Positive Electrode

A 10 μm-thick aluminum foil was used as a positive electrode current collector.

A functional layer slurry was prepared by mixing hexagonal boron nitride (D50=5 μm), LiFePO₄ as a lithium iron phosphate-based compound and polyacrylic acid (PAA) as a binder in a weight ratio of 53:40:7, and then dispersing the mixture in N-methyl-2-pyrrolidone. The functional layer slurry was coated to be 7 μm to 10 μm thick on both sides of the aluminum foil to form a functional layer.

A positive electrode slurry was prepared by mixing LiNi_{0.91}Co_{0.05}Al_{0.04}O₂ as a positive electrode active material, polyvinylidene fluoride (PVDF) as a binder, and carbon as a conductive agent in a weight ratio of 92:4:4, and then adding the mixture into N-methyl-2-pyrrolidone. The slurry was coated to be 70 μm to 80 μm thick on the functional layers on both sides of the aluminum foil to form a positive electrode active material layer.

### (2) Manufacturing of Negative Electrode

Artificial graphite and silicon particles were mixed in a weight ratio of 93.5:6.5 to prepare a negative electrode active material, and the negative electrode active material:styrene-butadiene rubber binder:carboxylmethyl cellulose were mixed in a weight ratio of 97:1:2, and then dispersed in distilled water to prepare a negative electrode slurry.

The negative electrode active material slurry was coated to be 90 to 100 μm thick on a 10 μm-thick Cu foil, and then dried at 100° C. and pressed to form a negative electrode active material layer.

### (3) Preparation of Electrolyte Solution

An electrolyte solution was prepared by mixing 1.5 M lithium salt (LiPF₆) with a carbonate solvent including ethylene carbonate (EC): ethyl methyl carbonate (EMC): dimethyl carbonate (DMC) mixed in a volume ratio of 20:40:40.

### (4) Manufacturing of Rechargeable Lithium Battery Cell

The manufactured positive and negative electrodes were assembled to obtain an electrode assembly, and then inserted into a prismatic case, and the electrolyte solution was injected thereinto to manufacture a rechargeable lithium battery cell.

### Example 2

A positive electrode and a rechargeable lithium battery cell were manufactured in the same manner as in Example 1, with a difference that polyvinyl alcohol (PVA) was used instead of the polyacrylic acid (PAA) as a binder to form the functional layer.

### Example 3

A positive electrode and a rechargeable lithium battery cell were manufactured in the same manner as in Example 1, with a difference that a mixture of polyacrylic acid (PAA) and polyvinyl alcohol (PVA) in a weight ratio of 1:6 was used instead of the polyacrylic acid (PAA) alone as a binder to form the functional layer.

### Example 4

A positive electrode and a rechargeable lithium battery cell were manufactured in the same manner as in Example 1, with a difference that a mixture of polyacrylic acid (PAA) and polyvinyl alcohol (PVA) in a weight ratio of 6:1 was used instead of the polyacrylic acid (PAA) alone as a binder to form the functional layer.

### Example 5

A positive electrode and a rechargeable lithium battery cell were manufactured in the same manner as in Example 1, with a difference that a mixture of polyacrylic acid (PAA) and polyvinyl alcohol (PVA) in a weight ratio of 3.5:3.5 (i.e., 1:1) was used instead of the polyacrylic acid (PAA) alone as a binder to form the functional layer.

### Example 6

A positive electrode and a rechargeable lithium battery cell were manufactured in the same manner as in Example 1, with a difference that polyvinylidene fluoride (PVDF) was used instead of the polyacrylic acid (PAA) alone as a binder to form the functional layer.

### Example 7

A positive electrode and a rechargeable lithium battery cell were manufactured in the same manner as in Example 1, with a difference that hexagonal boron nitride (D50=5 μm), LiFePO₄ as a lithium iron phosphate-based compound, and polyvinylidene fluoride (PVDF) as a binder were mixed in a weight ratio of 45:40:15 to form the functional layer.

### Comparative Example 1

A positive electrode and a rechargeable lithium battery cell were manufactured in the same manner as in Example 1, with a difference that hexagonal boron nitride (D50=5 μm), polyvinyl alcohol (PVA) as a binder, and polyvinylidene fluoride (PVDF) were mixed in a weight ratio of 93:1:6 to form the functional layer.

### Comparative Example 2

A positive electrode and a rechargeable lithium battery cell were manufactured in the same manner as in Example 1, with a difference that LiFePO₄ as a lithium iron phosphate-based compound, polyvinyl alcohol (PVA) as a binder, and polyvinylidene fluoride (PVDF) were mixed in a weight ratio of 93:1:6 to form the functional layer.

Each of the functional layer compositions of Examples 1 to 7 and Comparative Examples 1 and 2 are summarized in Table 1.

TABLE 1

| | Functional layer composition (unit: wt %) | | | | |
|---|---|---|---|---|---|
| | BN | LFP | PAA | PVA | PVdF |
| Example 1 | 53 | 40 | 7 | 0 | 0 |
| Example 2 | 53 | 40 | 0 | 7 | 0 |
| Example 3 | 53 | 40 | 1 | 6 | 0 |
| Example 4 | 53 | 40 | 6 | 1 | 0 |
| Example 5 | 53 | 40 | 3.5 | 3.5 | 0 |
| Example 6 | 53 | 40 | 0 | 0 | 7 |
| Example 7 | 45 | 40 | 0 | 0 | 15 |
| Comparative Example 1 | 93 | 0 | 0 | 1 | 6 |
| Comparative Example 2 | 0 | 93 | 0 | 1 | 6 |

### Evaluation Example 1: Evaluation of Positive Electrode

Each of the positive electrodes of Examples 1 to 7 and Comparative Examples 1 and 2 was evaluated in the following method, and the results are shown in Table 2.
(1) Resistance: Resistivity (resistance passing through the positive electrodes in a vertical direction) was measured. The resistivity refers to current resistance and was measured by using an electrode resistance meter (in-plane, Hioki E.E. Corp.).
(2) Adhesive Strength: Peel strength was measured in a method according to ASTM D3330. The measurement was performed by using UTM, Instron 3345. Each of the positive electrodes was cut into a size of 25 mm×150 mm to respectively prepare 20 specimens. After coating an adhesive on a glass substrate at room temperature, attaching each positive electrode plate on the adhesive, roll-pressing the positive electrode plates, and folding one end of the positive electrode by 180°, a force applied thereto was measure, while pulling at 100 mm/min in the opposite direction to the one end of the positive electrode.
(3) Nail Penetration: An iron nail with a diameter of 3 mm was prepared and penetrated through each of the cells at 100 mm/s. The same process was 10 times repeated to express the number of times that failed in the penetration test as n/10.
(4) Positive Electrode Mixture Density: obtained by dividing a weight of an active material layer excluding a current collector and a functional layer in each positive electrode by a volume thereof.

TABLE 2

| | | | | Positive |
|---|---|---|---|---|
| | | | | electrode |
| | | Adhesive | | active mass |
| | Resistance | strength | Penetration | density |
| | (Ω) | (gf/mm) | (Fail/Total) | (g/cc) |
| Example 1 | 121.3 | 20.8 | 1/10 | 4.04 |
| Example 2 | 118.5 | 17.2 | 2/10 | 4.03 |
| Example 3 | 112.9 | 55.78 | 0/10 | 4.06 |
| Example 4 | 118.5 | 26.71 | 0/10 | 4.05 |
| Example 5 | 117.1 | 33.51 | 0/10 | 4.06 |
| Example 6 | 115.5 | 14.66 | 2/10 | 4.03 |
| Example 7 | 102.6 | 26.5 | 1/10 | 3.92 |
| Comparative | 921 | 16.73 | 1/10 | 4.00 |
| Example 1 | | | | |
| Comparative | 38.8 | 63.95 | 6/10 | 3.89 |
| Example 2 | | | | |

### Evaluation Example 2: Evaluation of Rechargeable Lithium Battery Cell

Each of the rechargeable lithium battery cells of Examples 1 to 7 and Comparative Examples 1 and 2 was evaluated in the following method, and the results are shown in Table 3 below.

In order to evaluate charge and discharge characteristics of the rechargeable lithium battery cells, the cells were charged to an upper limit voltage of 4.5 V under a constant current of 0.2 C and at 0.02 C under the constant voltage, and then discharged to a cut-off voltage of 2.75 V at 0.2 C at 23° C. for initial charging and discharging. Subsequently, the cells were charged to an upper limit voltage of 4.2 V under a constant current of 1.3 C and at 1.0 C at the constant voltage, and then discharged to a cut-off voltage of 3.2 V at 0.5 C at the same temperature as above to measure charge capacity and discharge capacity at the 50^{th} cycle, and then calculate a ratio of the latter to the former as efficiency.

TABLE 3

| | 50^{th} cycle | 1^{st} cycle | 50^{th} cycle |
|---|---|---|---|
| | discharge | discharge | to 1^{st} cycle |
| | capacity | capacity | efficiency |
| | mAh | mAh | % |
| Example 1 | 4241 | 4713 | 89.99 |
| Example 2 | 4217 | 4710 | 89.53 |
| Example 3 | 4358 | 4715 | 92.43 |
| Example 4 | 4291 | 4713 | 91.05 |
| Example 5 | 4309 | 4715 | 91.39 |
| Example 6 | 4183 | 4710 | 88.81 |
| Example 7 | 4225 | 4699 | 89.91 |
| Comparative Example 1 | (cycle-life | 4701 | (cycle-life |
| | extinction) | | extinction) |
| Comparative Example 2 | 4376 | 4700 | 93.11 |

As a result of examining the above, the positive electrodes or a rechargeable lithium battery, which were represented by Examples 1 to 5, were confirmed to secure safety, even when a functional layer was formed to be thin, but not reduce battery capacity.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the appended claims.

### DESCRIPTION OF SYMBOLS

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A positive electrode for a rechargeable lithium battery, the positive electrode comprising:
a positive electrode current collector;
a functional layer disposed on the positive electrode current collector and comprising a boron nitride and a lithium iron phosphate-based compound; and
a positive electrode active material layer disposed on the functional layer and comprising a positive electrode active material.

2. The positive electrode as claimed in claim 1, wherein the boron nitride comprises hexagonal boron nitride (h-BN).

3. The positive electrode as claimed in claim 1, wherein based on a total amount of 100 wt % of the functional layer, the boron nitride is included in an amount in a range of about 80 wt % to about 90 wt %.

4. The positive electrode as claimed in claim 1, wherein the lithium iron phosphate-based compound is represented by Chemical Formula 1: 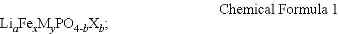
wherein, in Chemical Formula 1,
0.9≤a≤1.8, 0.6≤x≤1, 0≤y≤0.4, and 0≤b≤0.1,
M comprises one or more of Al, B, Ba, Ca, Ce, Co, Cr, Cu, Mg, Mn, Mo, Ni, Se, Si, Sn, Sr, Ti, V, W, Y, Zn, and Zr, and
X comprises one or more of F, P, and S.

5. The positive electrode as claimed in claim 4, wherein Chemical Formula 1 comprises LiFePO₄.

6. The positive electrode as claimed in claim 1, wherein based on a total amount of 100 wt % of the functional layer, the lithium iron phosphate-based compound is included in an amount in a range of about 10 wt % to about 20 wt %.

7. The positive electrode as claimed in claim 1, wherein:
the functional layer further comprises a binder, and
the binder comprises at least one of:
a non-aqueous binder comprising at least one of polyvinylchloride, carboxylated polyvinylchloride, polyvinylfluoride, ethylene propylene copolymer, polystyrene, polyurethane, polytetrafluoroethylene, polyvinylidene fluoride, polyethylene, polypropylene, polyamideimide, polyimide, and a combination thereof; and
an aqueous binder comprising at least one of a styrene-butadiene rubber, a (meth)acrylated styrene-butadiene rubber, a (meth)acrylonitrile-butadiene rubber, a (meth)acrylic rubber, butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

8. The positive electrode as claimed in claim 1, wherein based on a total amount of 100 wt % of the functional layer, the binder is included in an amount in a range of about 0.5 wt % to about 5 wt %.

9. The positive electrode as claimed in claim 1, wherein a thickness of the functional layer is in a range of about 0.1 to about 3 μm.

10. The positive electrode as claimed in claim 1, wherein a thickness ratio of the functional layer and the positive electrode active material layer is less than about 1/15.

11. The positive electrode as claimed in claim 1, wherein:
the functional layer and the positive electrode active material layer are located on both surfaces of the positive electrode current collector,
the functional layer comprises:
a first functional layer on a first surface of the positive electrode current collector; and
a second functional layer on a second surface of the positive electrode current collector, and
the positive electrode active material layer comprises:
a first positive electrode active material layer on the first functional layer; and
a second positive electrode active material layer on the second functional layer.

12. The positive electrode as claimed in claim 1, wherein the positive electrode active material comprises a lithium transition metal composite oxide.

13. A rechargeable lithium battery, comprising:
the positive electrode as claimed in claim 1;
a negative electrode;
a separator between the positive electrode and the negative electrode, and
an electrolyte solution.
